(19) United States
(12) Patent Application Publication
(10) Pub. No.: US 2008/0025693 A1
(43) Pub. Date: Jan. 31, 2008

(54) Method and apparatus for recording and reproducing broadcasting program

(75) Inventor: Hwa-kyung Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/635,587

(22) Filed: Dec. 8, 2006

(30) Foreign Application Priority Data
Jul. 28, 2006 (KR) 10-2006-0071572

(51) Int. Cl. H04N 5/91

(52) U.S. Cl. 386/83

(57) ABSTRACT

A method and apparatus are provided which enable a user to easily and simply record and reproduce a broadcasting program. The method includes receiving and storing recording information regarding a broadcasting program that is to be recorded and a user-defined channel that is to be allocated to the broadcasting program; recording the broadcasting program with reference to the recording information; and reproducing the recorded broadcasting program corresponding to the user-defined channel with reference to the recording information, if the user-defined channel is selected by a user. When the method and apparatus are used, recorded content can be reproduced by simply selecting a channel. Therefore, there is no need to search for the recorded content, and this increases user convenience.

This application claims priority from Korean Patent Application No. 10-2006-0071572, filed on Jul. 28, 2006, in the Korean Intellectual Property Office, the disclosure of which is incorporated herein by reference in its entirety.

### BACKGROUND OF THE INVENTION

1. Field of the Invention

Methods and apparatuses consistent with the present invention relate to recording a broadcasting program, and more particularly, to enabling a user to easily and simply record and reproduce a broadcasting program.

2. Description of the Related Art

FIG. 1 illustrates the configuration and operation of a related art personal video recorder (PVR) 100.

Referring to FIG. 1, a user 120 selects a broadcasting program desired for recording on a reservation screen 112, which is displayed on a display 110. The reservation screen 112 is configured using an electronic program guide (EPG), and the user 120 may select immediate recording or reserved recording on the reservation screen 112. A recording processing unit 102 of the PVR 100 processes a recording request made by the user 120, and a content repository 130 stores a recorded broadcasting program. In the case of reserved recording, recording starts at a time set by the user 120. In the case of reserved recording of a particular broadcasting program, the broadcasting program is recorded when the particular broadcasting program starts.

In order to watch a recorded broadcasting program, the user 120 has to search for and select the recorded broadcasting program on a content selection and reproduction screen 114, on which a list of content is displayed, and must then press a reproduction button.

According to a conventional reserved recording method, a user can instruct program recording, but cannot pre-select a time for reproducing a recorded program. Therefore, the user must search for desired content and reproduce the desired content at a desired time.

In addition, if there are many recorded broadcasting programs, or if the recorded programs are not classified, it is difficult for the user to find the desired content.

When recording and watching a series, if a broadcasting program, i.e., an installment of a series, has been reproduced, a user has to return to a content list screen and select and reproduce a next broadcasting program, i.e., a next installment of the series. The user may select a plurality of broadcasting programs at a time and issue a command to sequentially reproduce the selected broadcasting programs. In this case, however, the user has to select the broadcasting programs according to an order in which the selected broadcasting programs are to be reproduced, which causes great inconvenience.

### SUMMARY OF THE INVENTION

The present invention provides a method and apparatus which enables a user to easily and simply reproduce recorded content at a desired time without searching for the recorded content.

According to an aspect of the present invention, there is provided a method of recording and reproducing a broadcasting program. The method includes receiving and storing recording information regarding a broadcasting program that is to be recorded and a user-defined channel that is to be allocated to the broadcasting program; recording the broadcasting program with reference to the recording information; and reproducing the recorded broadcasting program corresponding to the user-defined channel with reference to the recording information, if the user-defined channel is selected by a user.

If the broadcasting program that is to be recorded is a series, the recording of the broadcasting program may include recording each installment of the series that is broadcasted.

The reproducing of the recorded broadcasting program may include reproducing a next installment of the series if an installment of the series has been reproduced.

The method may further include storing information regarding a current reproduction position of the recorded broadcasting program that is currently being reproduced if the reproduction of the recorded broadcasting program on the user-defined channel is stopped; and reproducing the recorded broadcasting program, whose reproduction was stopped, from the stored current reproduction position if the user-defined channel is selected again.

The receiving and storing of the recording information may further include receiving and storing a user-defined broadcasting time to reproduce the recorded broadcasting program, and the reproducing of the recorded broadcasting program may include reproducing the recorded broadcasting program at the user-defined broadcasting time on the user-defined channel.

The reproducing of the recorded broadcasting program may include reproducing the recorded broadcasting program from a position corresponding to a time when the user-defined channel is selected.

The receiving and storing of the recording information may include receiving and storing information regarding a plurality of broadcasting programs and a user-defined broadcasting time corresponding to each broadcasting program for one user-defined channel.

The receiving and storing of the recording information may include receiving and storing information regarding all broadcasting programs of a general broadcasting channel for one user-defined channel.

According to another aspect of the present invention, there is provided an apparatus for recording and reproducing a broadcasting program. The apparatus includes an input unit used by a user to input channel selection and recording information; a control unit including a recording information processing unit receiving and storing recording information regarding a broadcasting program that is to be recorded and a user-defined channel that is to be allocated to the broadcasting program, a recording processing unit recording the broadcasting program with reference to the recording information, and a reproduction processing unit reproducing the recorded broadcasting program corresponding to the user-defined channel with reference to the recording information if the user-defined channel is selected by the user through the input unit; and a storage unit storing the recording information input through the input unit and the recorded broadcasting program.

### BRIEF DESCRIPTION OF THE DRAWINGS

The aspects of the present invention will become more apparent by describing in detail exemplary embodiments thereof with reference to the attached drawings, in which:

FIG. 1 illustrates the configuration and operation of a related art PVR;

FIG. 2 is a block diagram of an apparatus for recording and reproducing a broadcasting program according to an exemplary embodiment of the present invention;

FIG. 3 is a flowchart illustrating a method of recording and reproducing a broadcasting program according to an exemplary embodiment of the present invention;

FIG. 4A illustrates an example of content recorded in a user-defined channel using the exemplary method of FIG. 3;

FIG. 4B illustrates another example of content recorded in a user-defined channel using the exemplary method of FIG. 3;

FIG. 5 is a flowchart illustrating a method of recording and reproducing a broadcasting program according to another exemplary embodiment of the present invention;

FIG. 6 illustrates an example of content recorded in a user-defined channel using the exemplary method of FIG. 5;

FIG. 7 is a flowchart illustrating a method of recording and reproducing a broadcasting program according to another exemplary embodiment of the present invention; and

FIG. 8 illustrates an example of content recorded in a user-defined channel using the exemplary method of FIG. 7.

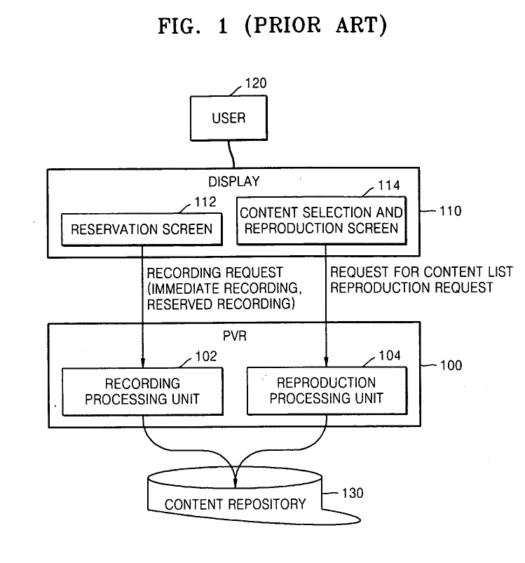

### DETAILED DESCRIPTION OF EXEMPLARY EMBODIMENTS OF THE INVENTION

Exemplary embodiments of the present invention will now be described more fully with reference to the accompanying drawings, in which exemplary embodiments of the invention are shown. The present invention may, however, be embodied in many different forms and should not be construed as being limited to the exemplary embodiments set forth therein; rather, these exemplary embodiments are provided for illustrative purposes so that this disclosure will be thorough and complete, and will fully convey the concept of the invention to those skilled in the art

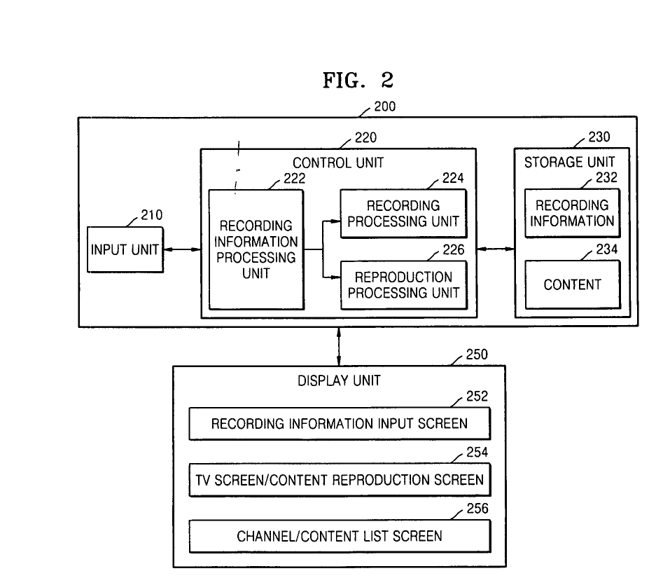

FIG. 2 is a block diagram of an apparatus 200 for recording and reproducing a broadcasting program according to an exemplary embodiment of the present invention.

Referring to FIG. 2, the apparatus 200 includes an input unit 210, a control unit 220, and a storage unit 230. The input unit 210is used by a user to select a channel and input recording information (232). The control unit 220 processes recording based on the recording information (232) input by the user and reproduces recorded content of the channel selected by the user. The storage unit 230 stores the recording information 232 input through the input unit 210 and content 234 recorded by the control unit 220. The apparatus 200 is connected to a display unit 250 which displays a recording information input screen 252 for interfacing with the user, a television (TV) screen/content reproduction screen 254 for watching a television program of a channel selected by the user or recorded content, and a channel/content list screen 256 for displaying information regarding a user-defined channel allocated by the user, or a list of broadcasting programs stored in each user-defined channel. The user may modify the recording information (232), e.g., information regarding a user-defined channel, a broadcasting program that is to be recorded, and/or a user-defined broadcasting time, through the channel/content list screen 256.

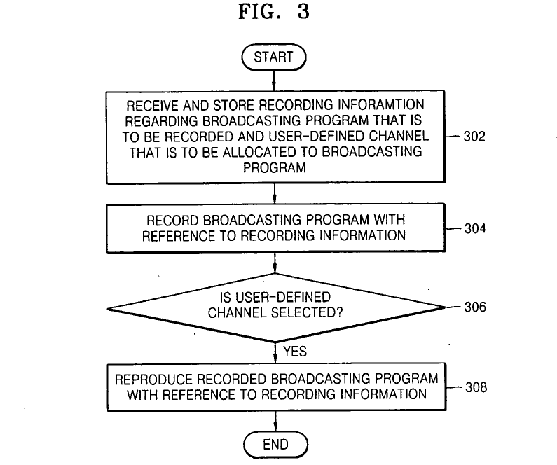

The control unit 220 includes a recording information processing unit 222 for receiving the recording information 232 regarding a broadcasting program that is to be recorded and regarding a user-defined channel that is to be allocated to the broadcasting program and for storing the received recording information 232. The recording information processing unit 222 obtains a broadcasting program that is to be recorded and a broadcasting time of the broadcasting program with reference to the stored recording information 232, determines when and which broadcasting program should be recorded, and instructs a recording processing unit 224 to record a broadcasting program desired by the user. In addition, if the user selects a user-defined channel through the input unit 210, the recording information processing unit 222 determines which broadcasting program should be reproduced with reference to the recording information 232, reads the determined broadcasting program from the storage unit 230, and instructs a reproduction processing unit 226 to reproduce the read broadcasting program. The operation of the control unit 220 will now be described in more detail with reference to FIGS. 3, 4, 5, 6, 7 and 8.

FIG. 3 is a flowchart illustrating a method of recording and reproducing a broadcasting program according to an exemplary embodiment of the present invention.

Referring to FIG. 3, the recording information processing unit 222 receives the recording information (232) regarding a broadcasting program desired for recording and regarding a user-defined channel that is to be allocated to the broadcasting program from a user through the input unit 210 and stores the received recording information 232 in the storage unit 230 (operation 302). The user may input the recording information 232 through the recording information input screen 252. The recording information input screen 252 may display electronic program guide (EPG) information so that the user can select a broadcasting program desired for recording. The recording information 232 may include, for example, an identifier of a broadcasting program that is to be recorded, a general broadcasting channel and a broadcasting time, and a user-defined channel number. With reference to the stored recording information 232, the recording information processing unit 222 instructs the recording processing unit 224 to record and store a broadcasting program that is desired by the user when the broadcasting time of the broadcasting program occurs (operation 304).

When the user selects or changes a channel through the input unit 210, the recording information processing unit 222 determines whether the selected or changed channel is a user-defined channel (operation 306). If the channel selected by the user is a user-defined channel, the recording information processing unit 222 determines recorded content that is to be reproduced with reference to the recording information 232 and instructs the reproduction processing unit 226 to read and reproduce a determined broadcasting program (operation 308). Alternatively, the user may select a menu for displaying the channel/content list screen 256 and select content desired for recording on the displayed channel/content list screen 256. However, this process is not necessary since the user can watch recorded content simply by selecting a channel according to the exemplary method illustrated in FIG. 3. If the channel selected by the user is a general channel (i.e., a non-user-defined channel), the user can watch a general TV channel corresponding to the selected channel.

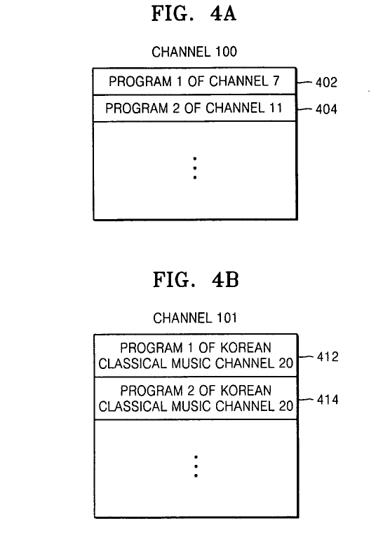

FIG. 4A illustrates an example of content recorded in a user-defined channel using the method of FIG. 3.

Referring to FIG. 4A, program 1 (402) of channel 7 and program 2 (404) of channel 11 selected by a user are recorded. In addition, channel 100, which is not used conventionally, is allocated to the recorded content. For example, each family member may set a user-defined channel as illustrated in FIG. 4A and watch desired broadcasting programs on the set user-defined channel.

FIG. 4B illustrates another example of content recorded in a user-defined channel using the method of FIG. 3.

Referring to FIG. 4B, programs 1, 2, . . . (412, 414, . . . ) broadcasted on a Korean classical music channel are continuously recorded in a user-defined channel, i.e., channel 101. This function is very useful for people who are not familiar with the apparatus 200 since broadcasting programs of a desired channel are continuously recorded in the user-defined channel and a user can always watch recorded content of the desired channel by selecting the user-defined channel.

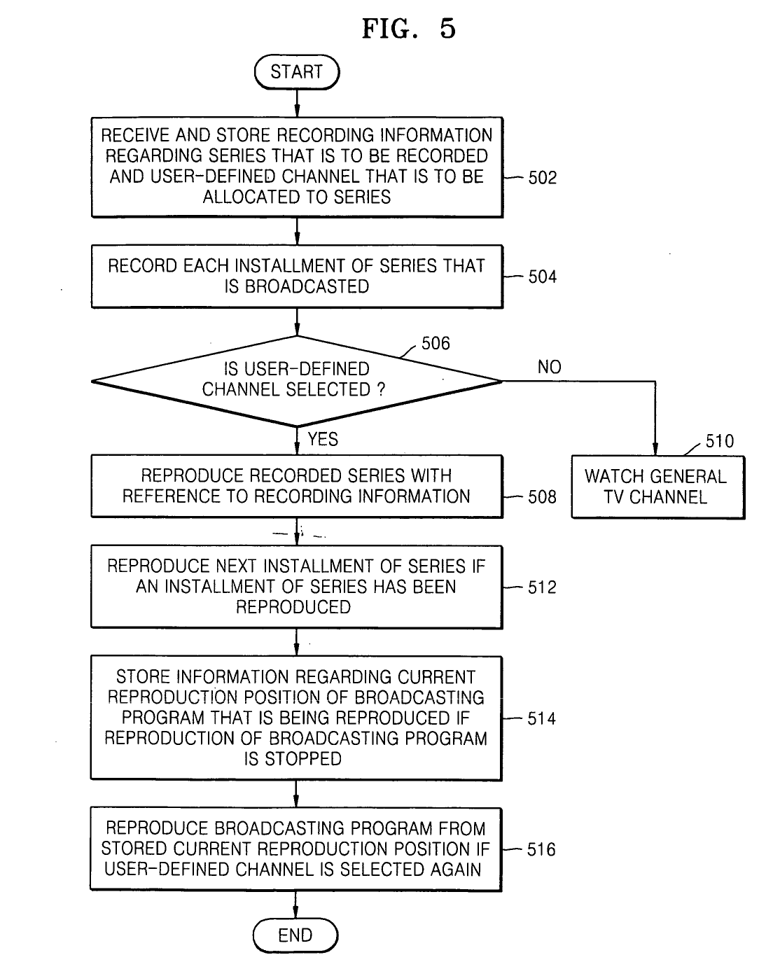

FIG. 5 is a flowchart illustrating a method of recording and reproducing a broadcasting program according to another exemplary embodiment of the present invention. In the present exemplary embodiment, a program that is to be recorded is a series.

Referring to FIG. 5, the recording information processing unit 222 receives and stores the recording information 232 regarding a series that is to be recorded and a user-defined channel that is to be allocated to the series (operation 502). A user interface used to receive the recording information 232 may be similar to that of the exemplary embodiment of FIG. 3. With reference to the stored recording information 232, the recording information processing unit 222 instructs the recording processing unit 224 to record the series whenever the series is broadcasted (operation 504).

When a user selects or changes a channel through the input unit 210, the recording information processing unit 222 determines whether the selected or changed channel is a user-defined channel (operation 506). If the channel selected by the user is a user-defined channel, the recording information processing unit 222 determines recorded content that is to be reproduced with reference to the recording information 232. Since the recorded content that is to be reproduced is the series in the present exemplary embodiment, the recording information processing unit 222 instructs the reproduction processing unit 226 to reproduce the recorded content, i.e., the series, from a first installment of the series (operation 508). If an installment of the series has been previously reproduced, the recording information processing unit 222 instructs the reproduction processing unit 226 to reproduce a next installment of the series (operation 512). If the user stops the reproduction of the series by changing the channel or by turning off the apparatus 200, the recording information processing unit 222 stores a current reproduction position of an installment being reproduced (operation 514). If the user selects the user-defined channel again, that is, if the user changes to the user-defined channel or turns on the apparatus 200, the recording information processing unit 222 instructs the reproduction processing unit 226 to reproduce the installment, whose reproduction was stopped, from the reproduction position stored in operation 514 (operation 516). This function, which enables a user who stopped watching a broadcasting program on a user-defined channel, to watch the same user-defined channel later from the position where the broadcasting program was stopped, may be applied to other exemplary embodiments of the present invention.

If the channel selected by the user is a general channel, the user can watch a general TV channel corresponding to the selected channel (operation 510).

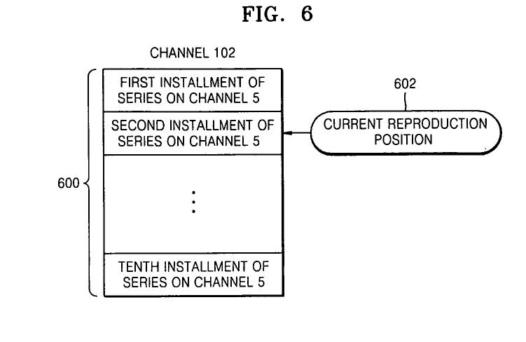

FIG. 6 illustrates an example of content recorded in a user-defined channel using the method of FIG. 5.

Referring to FIG. 6, first through tenth installments of a series 600 of channel 5 selected by a user are recorded in a user-defined channel, i.e., channel 102. If the series 600 is broadcasted on channel 5 at 8 o'clock every day, the respective installment of the series 600 would have been stored in the storage unit 230 at 8 o'clock every day. As shown in FIG. 6, the user has watched the first installment of the series 600 and has stopped watching the series 600 while watching the second installment. In this case, information regarding a current reproduction position 602 is stored in the storage unit 230 by the reproduction processing unit 226 in order to support a seamless viewing function. If a number of user-defined channels are defined, and if different series are recorded in each user-defined channel, a user who enjoys watching a series can record and reproduce the series very easily.

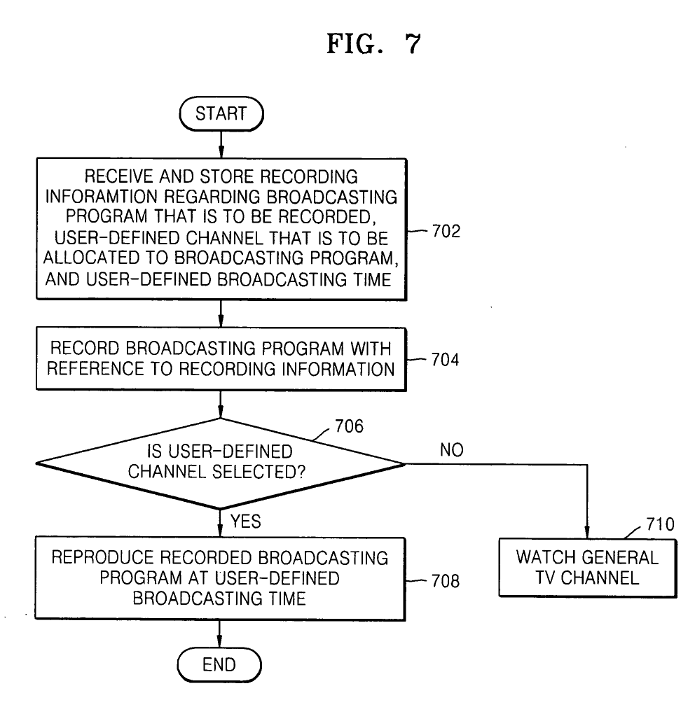

FIG. 7 is a flowchart illustrating a method of recording and reproducing a broadcasting program according to another exemplary embodiment of the present invention.

Referring to FIG. 7, the recording information processing unit 222 receives the recording information 232 regarding a broadcasting program desired for recording, a user-defined channel that is to be allocated to the broadcasting program, and a user-defined broadcasting time and stores the received recording information 232 in the storage unit 230 (operation 702). The user-defined broadcasting time denotes the time to reproduce a recorded broadcasting program. If a user selects a user-defined channel at a user-defined broadcasting time, the user can watch a recorded broadcasting program as if the recorded broadcasting program was broadcasted in real-time. In addition, the user may set a plurality of broadcasting programs for a user-defined channel and may set a user-defined broadcasting time for each broadcasting program, thereby creating a private channel schedule table. Therefore, the user can watch a desired broadcasting program at a desired broadcasting time according to the channel schedule table. With reference to the stored recording information 232, the recording information processing unit 222 instructs the recording processing unit 224 to record and store a broadcasting program selected by the user when the broadcasting time of the selected broadcasting program occurs (operation 704).

When the user selects or changes a channel through the input unit 210, the recording information processing unit 222 determines whether the selected or changed channel is a user-defined channel (operation 706). If the channel selected by the user is a user-defined channel, then the recording information processing unit 222 determines recorded content that is to be reproduced with reference to the recording information 232 and instructs the reproduction processing unit 226 to read and reproduce a determined broadcasting program (operation 708). Since even the reproduction time is based on information set by the user in the present exemplary embodiment, a recorded broadcasting program is reproduced at a user-defined broadcasting time. In addition, the recorded program is reproduced from a position corresponding to a time when the user selected the user-defined channel. If the channel selected by the user is a general channel, then the user can watch a general TV channel corresponding to the selected channel (operation 710).

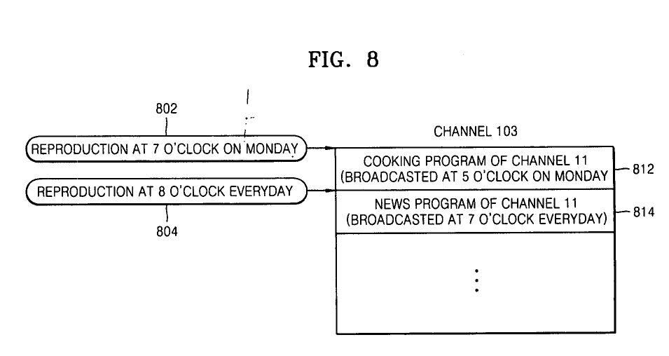

FIG. 8 illustrates an example of content recorded in a user-defined channel using the method of FIG. 7.

FIG. 8 shows a user selected a cooking program 812 of channel 11, which is broadcasted at 5 o'clock on Monday and a news program 814 of channel 11, which is broadcasted at 7 o'clock everyday. FIG. 8 also shows an that channel 103 has been allocated to the selected cooking program 812 and the news program 814. The user may also set a time to watch each recorded broadcasting program. In FIG. 8, for instance, the user desires to watch the cooking program 812, which is broadcasted at 5 o'clock, at a user-defined broadcasting time 802 of 7 o'clock since the user arrives home at 7 o'clock. Further, as shown in FIG. 8, the user desires to watch the news program 814, which is broadcasted at 7 o'clock everyday, at a user-defined broadcasting time 804 of 8 o'clock. Therefore, if the user selects channel 103 at 7 o'clock on Monday, the cooking program 812 will be reproduced, and the new program 814 will be reproduced beginning at 8 o'clock after the cooking program 812 ends. Since the user set the cooking program 812 to be reproduced at the user-defined broadcasting time 802 of 7 o'clock on Monday, if the user selects channel 103 at 7:30, the recorded cooking program 812 will be reproduced from a position corresponding to 30 minutes after 7 o'clock.

In the case of a broadcasting program that is broadcasted weekly, recorded content may replaced by a new program every week. In the case of a program that is broadcasted everyday, recorded content may be replaced by a new program everyday. For example, the news program 814, which is broadcasted at 7 o'clock everyday, may be replaced by a news program which is newly broadcasted at 7 o'clock everyday. Therefore, the user can watch news of the day at 8 o'clock everyday on channel 103.

As described above, a method and apparatus for recording and reproducing a broadcasting program according to exemplary embodiments of the present invention enables a user to record desired broadcasting programs to a desired channel and to reproduce recorded content by selecting a channel. Therefore, there is no need for the user to search for the recorded content, and this increases user convenience.

Furthermore, a series desired by the user can automatically and continuously be recorded in a user-defined channel.

Even when the user turns off a personal video recorder (PVR), or changes a channel while a recorded broadcasting program is being reproduced on a user-defined channel, if the user turns on the PVR or returns to the user-defined channel, the user can watch the recorded broadcasting program from the position at which it was stopped.

The present invention can also be implemented as computer-readable code on a computer-readable recording medium.

While this invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of recording and reproducing a broadcasting program, the method comprising:
receiving and storing recording information regarding a broadcasting program and a user-defined channel;
allocating the broadcasting program to the user-defined channel;
recording the broadcasting program with reference to the recording information; and
reproducing the recorded broadcasting program with reference to the recording information, if the user-defined channel is selected.

2. The method of claim 1, wherein, if the broadcasting program is a series, the recording of the broadcasting program comprises recording a plurality of installments of the series.

3. The method of claim 2, wherein the reproducing of the recorded broadcasting program comprises reproducing a subsequent installment of the series, if an installment of the series has been previously reproduced.

4. The method of claim 1, further comprising:
stopping the reproducing of the recorded broadcasting program;
storing information regarding a current reproduction position of the recorded broadcasting program that was stopped; and
resuming reproducing the recorded broadcasting program, whose reproduction was stopped, from the stored current reproduction position, if the user-defined channel is selected.

5. The method of claim 1, wherein the receiving and storing of the recording information further comprises receiving and storing a user-defined broadcasting time at which to reproduce the recorded broadcasting program; and
wherein the reproducing of the recorded broadcasting program comprises reproducing the recorded broadcasting program at the user-defined broadcasting time on the user-defined channel.

6. The method of claim 1, wherein the reproducing of the recorded broadcasting program comprises reproducing the recorded broadcasting program from a position corresponding to a time when the user-defined channel is selected.

7. The method of claim 5, wherein the receiving and storing of the recording information comprises receiving and storing information regarding a plurality of broadcasting programs and regarding a user-defined broadcasting time corresponding to each of the plurality of broadcasting programs, wherein the plurality of broadcasting programs are reproduced on one user-defined channel.

8. The method of claim 1, wherein the receiving and storing of the recording information comprises receiving and storing information regarding all broadcasting programs of a general broadcasting channel, wherein all the broadcasting programs of the general broadcasting channel are reproduced on one user-defined channel.

9. An apparatus for recording and reproducing a broadcasting program, the apparatus comprising:
an input unit which inputs channel selection and recording information;
a control unit comprising:
a recording information processing unit which receives and stores recording information regarding a broadcasting program and a user-defined channel that is allocated to the broadcasting program,
a recording processing unit which records the broadcasting program with reference to the recording information; and
a reproduction processing unit which reproduces the recorded broadcasting program with reference to the recording information, if the user-defined channel is selected through the input unit; and
a storage unit which stores the recording information input through the input unit and which stores the recorded broadcasting program.

10. The apparatus of claim 9, wherein, if the broadcasting program is a series, the recording processing unit records a plurality of installments of the series.

11. The apparatus of claim 10, wherein the reproduction processing unit reproduces a subsequent installment of the series, if an installment of the series has been previously reproduced.

12. The apparatus of claim 9, wherein the reproduction processing unit stops reproduction of the recorded broadcasting program that is being reproduced, stores, in the storage unit, information regarding a current reproduction position of the recorded broadcasting program that was stopped, and reproduces the recorded broadcasting program, whose reproduction was stopped, from the stored current reproduction position, if the user-defined channel is selected.

13. The apparatus of claim 9, wherein the recording information processing unit receives a user-defined broadcasting time at which to reproduce the recorded broadcasting program,
stores the user-defined broadcasting-time, and
wherein the reproduction processing unit reproduces the recorded broadcasting program at the user-defined broadcasting time on the user-defined channel.

14. The apparatus of claim 9, wherein the reproduction processing unit reproduces the recorded broadcasting program from a position corresponding to a time when the user-defined channel is selected.

15. The apparatus of claim 13, wherein the recording information processing unit receives and stores information regarding a plurality of broadcasting programs and regarding a user-defined broadcasting time corresponding to each of the plurality of broadcasting programs, wherein the plurality of broadcasting programs are reproduced on one user-defined channel.

16. The apparatus of claim 9, wherein the recording information processing unit receives and stores information regarding all broadcasting programs of a general broadcasting channel, wherein all the broadcasting programs of the general broadcasting channel are reproduced on one user-defined channel.
